(19) United States
(12) Patent Application Publication
(10) Pub. No.: US 2011/0318014 A1
(43) Pub. Date: Dec. 29, 2011

(54) NOISE SUPPRESSION IN AN OPTICAL APPARATUS

(75) Inventors: Tuomo VON LERBER, Helsinki (FI); Marco MATTILA, Espoo (FI); Ari TERVONEN, Vantaa (FI); Werner WEIERSHAUSEN, Eppertshausen (DE)

(73) Assignee: LUXDYNE OY, Helsinki (FI)

(21) Appl. No.: 13/227,140

(22) Filed: Sep. 7, 2011

Related U.S. Application Data
(63) Continuation of application No. PCT/FI2010/050206, filed on Mar. 18, 2010.
(60) Provisional application No. 61/174,053, filed on Apr. 30, 2009.

(30) Foreign Application Priority Data
Mar. 19, 2009 (FI) 20095288

(51) Int. Cl. H04B 10/00

(52) U.S. Cl. 398/115; 398/174

(57) ABSTRACT

Apparatus for processing an optical signal carrying symbols. Modulation conversion means converts the optical signal from a first format, wherein each symbol has a unique nominal phase, to a second format, wherein each symbol has a unique combination of nominal phase and nominal amplitude. The modulation conversion means includes a signal splitter for splitting the optical input signal into two optical partial signals, which are directed to respective optical paths. Delay elements cause a mutual temporal difference between the two optical partial signals, which are processed in at least one non-linear regenerator having at least two ports and a gain which depends on the combined signal power directed to the at least two ports. The apparatus directs the optical partial signals from the modulation conversion means to an internal or external photo detector stage in the second format.

### CROSS-REFERENCE TO RELATED APPLICATIONS

This application is a national-phase continuation of PCT/FI2010/050206, published as WO2010/106231A1, which application claims priority from Finnish Patent Application 20095288, filed 19 Mar. 2009, and from U.S. provisional patent application 61/174,053, filed 30 Apr. 2009.

### FIELD OF THE INVENTION

The invention generally relates to reception of optically transmitted signals and particularly to apparatuses and methods for suppression of noise in connection with reception of optically transmitted telecommunication signals encoded in BPSK (binary phase-shift keying and QPSK (quaternary phase-shift keying) modulation formats as well as in variations of these formats, such as DPSK (differential phase-shift keying) and DQPSK (differential quaternary phase-shift keying).

### BACKGROUND OF THE INVENTION

In QPSK modulation, which is used as an illustrative but non-restrictive example for describing the invention, signal is transmitted in bit pairs. In other words, one symbol contains two bits of information. The four possible bit pairs are encoded into four different phase values, which can be absolute phase values or relative phase differences between two consecutive symbols. This is illustrated schematically in FIG. 1, wherein reference numeral 1-1 denotes a sequence of five optical pulses, each of which carries a symbol, in a diagram wherein t denotes time and I denotes signal intensity. The first pulse carries a symbol with a phase value of −3π/4, which signifies bit pair ‘00’. Reference numeral 1-2 denotes the bit pair values of the five pulses of the sequence 1-1. Reference numeral 1-3 denotes an idealized waveform in terms of intensity versus time. The idealized signal exhibits a normalized amplitude of one. Reference numeral 1-4 schematically represents the time-to-intensity relationship of real-world signals whose amplitude deviates from the nominal value, as shown by the two dashed lines 1-5.

Reference numeral 1-6 denotes an idealized constellation diagram, in which the radius of a circle denotes the maximum amplitude of the optical pulse carrying the symbol (normalized as one), while the anti-clockwise angle from the real axis Re denotes phase. In the present modulation scheme, the nominal (ideal) phase values are π/4, 3π/4, −3π/4 and −π/4, which is why the constellation diagram 1-6 comprises only four points, which are the intersections of a unity-radius circle and the four possible phase angles. The relation between symbol pair values and phase angles in the constellation diagram 1-6 corresponds to Gray encoding, in which only one bit changes at a time with increasing phase value, but those skilled in the art will realize that the problem and its inventive solution are not restricted to any particular encoding scheme. Real-world optical transmission systems are not ideal, however, and the signal deviates from the idealized representation given in the diagram 1-6. Because of phase and amplitude noise, real-world optical transmission systems produce signals whose constellation diagrams resemble the one denoted by reference numeral 1-7.

BPSK modulation format is a subset of QPSK modulation. Instead of four different phase values, the BPSK modulation contains just two possible phase values, their relative phase difference being yr radians. Consequently, BPSK modulation carries only one bit of information in each symbol.

As shown in the diagrams 1-1, the waveform's amplitude alternates from zero to unity (or to the noise-affected value 1-5) and back to zero for each symbol. This kind of amplitude variation is called return-to-zero (rz) amplitude modulation, but other modulation schemes are possible, such as non-return-to-zero (nrz) amplitude modulation. In many practical phase modulation formats the rz amplitude modulation is superimposed on top of the phase modulation. In such modulation schemes, it is not necessary for the amplitude modulation to carry net information (user information). Instead the amplitude modulation may carry a timing reference for demarcating the individual optical pulses that carry the symbols. Alternatively, the amplitude modulation may be used to reduce possible signal distortions, which may be caused by abrupt changes of signal phase. Within such modulation schemes, user information is typically carried by phase modulation. Later in this document, a phase-modulated signal means a signal in which user information is entirely or predominantly carried by variations in phase, whereas a phase/amplitude modulated signal means a signal in which user information is carried by variations in phase and amplitude.

FIG. 3 shows an example of a conventional DPSK receiver 3-0. Or, to put it more precisely, reference numeral 3-0 denotes the section of the DPSK receiver that processes signals in the optical domain, whereby the components of the electric domain, which can be entirely conventional, are omitted for the sake of clarity. The two major sections of the circuit 3-0 are a delay interferometer 3-1 and a detection stage 3-5. The first delay interferometer 3-1 comprises a first 3 dB coupler 3-11 and a second 3 dB coupler 3-13. The couplers 3-11 and 3-13 are connected by two optical paths. As is well known to those skilled in the art, optical signal processing circuits frequently process optical signals in two parallel optical paths. Within this document, the two optical paths are arbitrarily denoted by A and B, and the circuit 3-0 comprises parallel optical paths 3-12A and 3-12B, which differ from one another in optical length.

The first and second optical paths 3-12A, 3-12B have different optical path lengths, and the difference is inversely proportional to the received symbol rate such that the phase modulated signal is transformed to an amplitude-modulated signal at the output of the delay interferometer. In effect, the optical path length difference equals the distance travelled by the optical signal in an optical medium in a time that corresponds to one symbol period, as known by those skilled in the art.

In the known optical receiver 3-0, the delay interferometer section 3-1 is followed by a detection stage 3-5 which comprises photo detection elements, such as photodiodes 3-51 and 3-52, for converting the amplitude-modulated signal in the optical domain into an amplitude-modulated signal in the electric domain, which follows the detection stage 3-5.

A generic problem in optical telecommunications is noise, as described in connection with FIG. 1. Noise can be reduced by signal regeneration circuits that precede the optical receiver.

FIG. 2 shows a BPSK regeneration circuit 2-0 described in reference document 1. Within the present patent specification, the beginning of a reference numeral or sign generally indicates the number of the Figure in which an element first appears; when that element is shown in later Figures, a detailed description may be omitted. As shown in FIG. 2, the regeneration circuit 2-0 begins at block or section 2-1, which is a delay interferometer and can be structurally and functionally identical with the corresponding section 3-1 in FIG. 3. In the regeneration circuit 2-0, the first delay interferometer 2-1 is followed by an amplitude regeneration section 2-3, which is followed by a second delay interferometer 2-4. The second delay interferometer 2-4 can be identical with the first delay interferometer 2-1.

The prior art amplitude regeneration section 2-3 comprises two 3 dB couplers 2-31, 2-32 and two semiconductor optical amplifiers (labelled “SOA”, denoted by reference numerals 2-33 and 2-34). In case of BPSK modulated signals, the two outputs of the coupler 2-13 of the first delay interferometer contain complementary high and low amplitude signals, which are both directed to the couplers 2-31 and 2-32. Both of these couplers divide the signals and direct them to the SOA components. The high amplitude signals are thus propagating through the SOAs in one direction and the low amplitude signals are propagating through the SOAs to the opposite direction. The regeneration effect described in reference document 1 is such that when high and low amplitude signals cross an amplifying medium, and especially when the high amplitude-signal saturates the gain of the amplifying medium, the low amplitude signal may experience a lower gain factor than the high amplitude signal. This means that the high amplitude signal is amplified relatively more than the low amplitude signal. In reference document 1 this process is called discriminative gain. The non-linear amplifying element is thus having a characteristic comparable to saturable absorption, where the low amplitude level signal is suppressed when compared to the high amplitude level signal. After the SOAs the high and low amplitude level signals are recombined in the couplers 2-31 and 2-32. The optical arrangement of two 3 dB couplers and two connecting optical paths are known in the art as the Mach-Zehnder interferometer. In case the optical paths are symmetric or have relatively similar characteristic, the Mach-Zehnder interferometer is known to direct the optical energy diagonally through the arrangement. In other words, the signal to the input 2-35 is directed to the output 2-38, while the signal to the input 2-36 is directed to the output 2-37. Therefore, in case of symmetric arrangement of couplers 2-31, 2-32 and optical paths containing the non-linear elements 2-33, 2-34, the high and low amplitude signals are directed to coupler 2-41 of the second delay interferometer 2-4, and not backwards to coupler 2-13 of the first delay interferometer 2-1.

Another regeneration scheme is disclosed in reference document 2. While the layouts of the amplitude regeneration sections disclosed in reference documents 1 and 2 are different, it can be seen that the two regeneration circuits share a common phase regeneration principle: a phase-modulated input signal, which suffers from phase noise, is applied to a first delay interferometer which converts the phase-modulated signal to an amplitude-modulated signal; after the phase-to-amplitude conversion the amplitude-modulated signal is regenerated. After the amplitude regeneration, the signal is applied to a second delay interferometer which converts the regenerated signal back to a phase-modulated output signal, which exhibits less phase noise than the input signal does.

The amplitude regenerator of reference document 1 is a coupled amplitude regenerator, whereas the one disclosed by reference document 2 is non-coupled. As used herein, a coupled amplitude regenerator means an amplitude regenerator in which there is some coupling between the two signal paths A and B within the amplitude regenerator. In contrast, the two signal paths of a non-coupled amplitude regenerator are not coupled to one another within the amplitude regenerator. A coupled amplitude regenerator provides the benefit over an uncoupled one that it is more readily implemented via non-linear amplification. Limiting amplification tends to be faster than non-linear attenuation in conventional semiconductor optical amplifiers. On the other hand, a non-coupled amplitude regenerator may provide other advantages, such as simpler construction and better yield in manufacturing.

Yet another BPSK regeneration scheme is disclosed in reference document 3, which suggests a phase-sensitive amplifier for phase noise averaging of consecutive optical pulses. The regeneration scheme disclosed in reference document 3 is based on self-phase modulation in highly non-linear fibers. Similar to the regeneration schemes disclosed in references 1 or 2, the technique of reference 3 is restricted to regeneration of BPSK-modulated signals. The scheme benefits of simple construction, but is more susceptible to amplitude noise than the schemes disclosed in references 1 or 2, which may limit its usefulness in real-life transmission systems.

A regeneration scheme of rz amplitude modulated signals is disclosed in references 4 and 5, which suggest the use of bandpass filtering in conjunction of self-phase modulated signal. Conventional techniques to compensate for the signal degradation due to noise typically involve correction of noise-induced bit errors in the electric domain by means of forward error-correction algorithms or RF filters.

A straightforward technique for reducing noise in an optical receiver 3-0 is regenerating the optical signal by a regeneration apparatus, such as one of the regeneration apparatuses disclosed in reference 1, 2, 4 or 5, prior to applying the optical signal to the optical receiver 3-0. It is an open question, however, whether such a straightforward combination of an optical regenerator and optical receiver provides optimal noise suppression performance.

### BRIEF DESCRIPTION OF THE INVENTION

An object of the invention is to develop further improvements to noise suppression in connection with optical reception and/or modulation format conversion circuits. Such improvements may relate to noise suppression performance, circuit complexity, manufacturing economics or any combination thereof. This object is achieved by apparatuses and methods as disclosed in the attached independent claims. The dependent claims and the present description with the attached drawings illustrate specific embodiments of the invention.

In order to keep the complexity of the description of the present invention within reasonable limits, the majority of the present description relates to modulation schemes in which all useful information is carried via phase modulation. It should be understood, however, that the invention is applicable to a variety of encoding schemes in which useful information is encoded by modulating one or more physical parameters such as phase, frequency and polarization state.

An aspect of the invention is an apparatus for processing an optical input signal carrying symbols, the apparatus comprising at least one optical system with the following elements:
modulation conversion means for converting the optical signal from a first modulation format to a second modulation format, wherein
the first modulation format involves a modulation of a set of physical parameters selected from a group consisting of phase, frequency and polarization state, such that each symbol has a unique nominal value of the set of physical parameters; and
the second modulation format is at least partially amplitude modulated, such that each symbol has a unique combination of nominal set of the physical parameters and nominal amplitude;
and wherein the modulation conversion means comprises:
a signal splitter for splitting the optical input signal into two optical partial signals, each of which is directed to a respective optical path;
delay elements for causing a mutual temporal difference between the two optical partial signals directed to the respective optical paths;
at least one non-linear regenerator having at least two ports and a gain which depends on the combined signal intensity directed to the at least two ports; and
means for directing the optical partial signals or derivatives thereof from the modulation conversion means to one or more photo detector stages in said at least partially amplitude-modulated format.

The one or more photo detector stages may be implemented as part of the inventive apparatus, in which case the invention is embodied as an optical receiver with improved noise suppression functionality. Alternatively, the invention may be embodied as a signal regenerator which is followed by the one or more photo detector stages. Each photo detector stage typically comprises a pair of photo detectors and a differential combiner operable to create a differential electrical signal from the photo detectors' outputs. Alternatively, the photo detector stages may be implemented by using only one photo detector for each pair of optical partial signals. While the one or more photo detector stages are necessary for converting the optical partial signals to an electrical signal, the invention may be embodied as a regenerator configured for acting as a front end to an optical receiver, which includes the photo detector stage(s). The benefits of the invention, such as improved noise suppression performance and/or reduction of apparatus complexity are equally achieved in embodiments relying on photo detector stages residing in external receivers.

In the above definition of the inventive apparatus, assuming that the parameter group being modulated includes phase, a signal in the first modulation format, which is at least partially phase modulated means that useful information is carried wholly or partially via phase modulation. A signal in the second modulation format, which is at least partially amplitude modulated, means that useful information is carried partially via amplitude modulation and partially via phase modulation. In modulation schemes in which the parameter group being modulated includes frequency or polarization state, these definitions should be adjusted accordingly. For the sake of clarity and brevity, phase will predominately be used as an example of the parameter being modulated in the first modulation format.

As stated in connection with FIG. 1, amplitude fluctuations from zero to unity and back for each symbol period do not carry “information” as the term is used within this document. Instead the amplitude fluctuations from zero to unity and back carry a timing reference for demarcating the individual optical pulses that carry the information-carrying symbols (by means of phase modulation). The fact that each symbol has a unique nominal phase value was described in connection with FIG. 1, in which reference numerals 1-6 and 1-7 respectively denoted an idealized constellation diagram and a schematic real-life constellation diagram. In the example shown in FIG. 1, four different nominal phase values, namely π/4, 3π/4, −3π/4 and −π/4 were assigned to four different symbols. In the example of FIG. 1, those symbols were the bit pairs 11, 01, 00 and 10, respectively, but the invention is applicable to any mapping between symbols and phase values. In the exemplary real-life constellation diagram 1-7, within each of the four dot concentrations, all dots have the same nominal phase (namely π/4, 3π/4, −3π/4 and −π/4) but varying amounts of phase noise as well as some amplitude noise. As is well known to those skilled in the art, all phase values are expressed in modulo 2π radians, which means that any integer multiple of 2π radians can be added to or subtracted from the given phase values.

As used herein, splitting the optical signal into two partial signals means that the signal splitter divides the signal energy into two parts. “Regeneration” or “amplitude regeneration” is a process which involves reduction of amplitude noise. Amplitude noise can be reduced by means of a non-linear amplifier or a combination of a linear amplifier and non-linear attenuator. “Modulation conversion” is a process for changing an optical signal's modulation to a different modulation format. For instance, the optical signal can be converted from a phase-modulation format to a phase/amplitude-modulation format or vice versa. Or, the optical signal can be converted from a phase-modulation format or phase/amplitude-modulation format, respectively, to a different phase-modulation format or phase/amplitude-modulation format. In sections wherein the optical signal is in the phase/amplitude modulation format, the optical signal usually propagates via two optical paths having complementary modulation with respect to one another.

In the modulation format conversion, when one symbol pair of the first phase/amplitude-modulated signal has nominal amplitude values of 0 or 1, this phase/amplitude-modulated signal is transformed to another phase/amplitude-modulated signal with a second symbol pair having nominal amplitude values of 0 and 1, wherein the phase difference of the second symbol pair differs from the phase difference of the first symbol pair.

Some embodiments employ a further noise-reduction technique, which is an enhanced implementation of a regeneration technique referred to as “Mamyshev” regeneration. At the regeneration or reception point, the signal is filtered from the noise with a bandpass filter, which retains the signal and the noise at the transmission band, but removes the noise from the other parts of the spectrum. The noisy amplitude-modulated signal is directed into a nonlinear element or medium, such as a highly nonlinear fiber, which broadens and/or shifts the spectrum of the signal by means of self-phase modulation. After the nonlinear element, the spectrally broadened and/or shifted signal is directed to a second bandpass filter that transmits parts of the broadened and/or shifted signal spectrum. While the input noise affects the spectral broadening and/or shifting, some of the noise can be suppressed by rejecting one or more portions of the spectrally broadened and/or shifted spectrum. The nature of the suppressed noise, and hence also the transmitted noise, can be tailored on the basis of the properties of the second bandpass filter, such as its transmission wavelength and bandwidth. Especially, the noise of a signal with a nominal amplitude value of 0 is suppressed when the second bandpass filter at least partially transmits at a signal band other than the first bandpass filter. On the other hand, the noise of the signal with nominal amplitude value of 1 is suppressed when the second bandpass filter effectively transmits the same signal band as the first bandpass filter, while the second bandpass filter rejects parts of the broadened/shifted signal spectrum.

As used herein, spectrum broadening by the nonlinear element means that any given percentage of signal energy occupies a broader band of the spectrum after the nonlinear element than before it. On the other hand, spectrum shifting means that the wavelength at which signal intensity has its maximum differs between the input and output sides of the nonlinear element. A feature common to both spectrum broadening and shifting is that after the broadening or shifting, a significant portion of signal energy resides in one or more spectrum bands which were substantially devoid of signal energy before the spectrum broadening or shifting.

Some embodiments of the inventive apparatus comprise two virtually identical optical systems in parallel. For instance, one of the parallel optical systems may process the I channel of DQPSK signals, while the other parallel system processes the Q channel. Some embodiments provide further savings in cost and complexity by utilizing common elements for both channels.

Other aspects of the invention include a method for processing an optical input signal carrying symbols, the method comprising:
the second modulation format is at least partially amplitude modulated, such that each symbol has a unique combination of nominal set of the physical parameters and nominal amplitude;
performing modulation conversion on the optical signal from a first modulation format to a second modulation format, wherein
the first modulation format involves a modulation of a set of physical parameters selected from a group consisting of phase, frequency and polarization state, such that each symbol has a unique nominal value of the set of physical parameters; and
the second modulation format is at least partially amplitude modulated, such that each symbol has a unique combination of nominal set of the physical parameters and nominal amplitude;
and wherein the modulation conversion means comprises:
splitting the optical input signal into two optical partial signals, each of which is directed to a respective optical path;
causing a mutual temporal difference between the two optical partial signals directed to the respective optical paths;
regenerating the two optical partial signals in at least one limiting amplifier having at least two ports and a gain which depends on the combined signal intensity directed to the at least two ports;
directing at least one of the regenerated optical partial signals to a photo detector stage;
keeping the two optical partial signals in said at least partially amplitude-modulated format from the modulation conversion to the photo detector stage.

### BRIEF DESCRIPTION OF THE DRAWINGS

In the following the invention will be described in greater detail by means of specific embodiments with reference to the attached drawings, in which

FIG. 1 schematically illustrates a QPSK modulation scheme, an ideal signal constellation and a signal constellation with a contribution from noise;

FIG. 2 shows a known phase regeneration scheme;

FIG. 3 shows an example of a conventional DPSK receiver;

FIG. 4 shows an embodiment of the present invention;

FIG. 5 is a set of constellation diagrams which further explain the operating principle of the embodiment shown in FIG. 4 in connection with DPSK modulation;

FIG. 6 shows the gain (transmission) curve of a typical nonlinear semiconductor optical amplifier;

FIG. 7 shows a DQPSK receiver which is enhanced according to the teaching of the present invention;

FIG. 8 is a set of six constellation diagrams, which further explain the operating principle of the embodiment shown in FIG. 7 in connection with QPSK modulation;

FIGS. 9 and 10 illustrate alternative construction implementations for the regeneration stage;

FIG. 11 shows an embodiment for DPSK operation, in which the amplitude regenerator is located within the delay interferometer;

FIGS. 12A, 12B and 13 show embodiments which are particularly insensitive to internal reflections within the SOA components;

FIG. 14 shows how the embodiment of FIG. 12B can be extended for DQPSK operation; and

FIGS. 15, 16 and 17 are yet other embodiments for DQPSK operation;

FIG. 18 further illustrates the Mamyshev regeneration according to an embodiment of the present invention; and

FIG. 19 shows how the invention can be embodied as an additional signal regenerator or noise suppression element, which is positioned in front of a conventional amplitude-sensitive optical receiver.

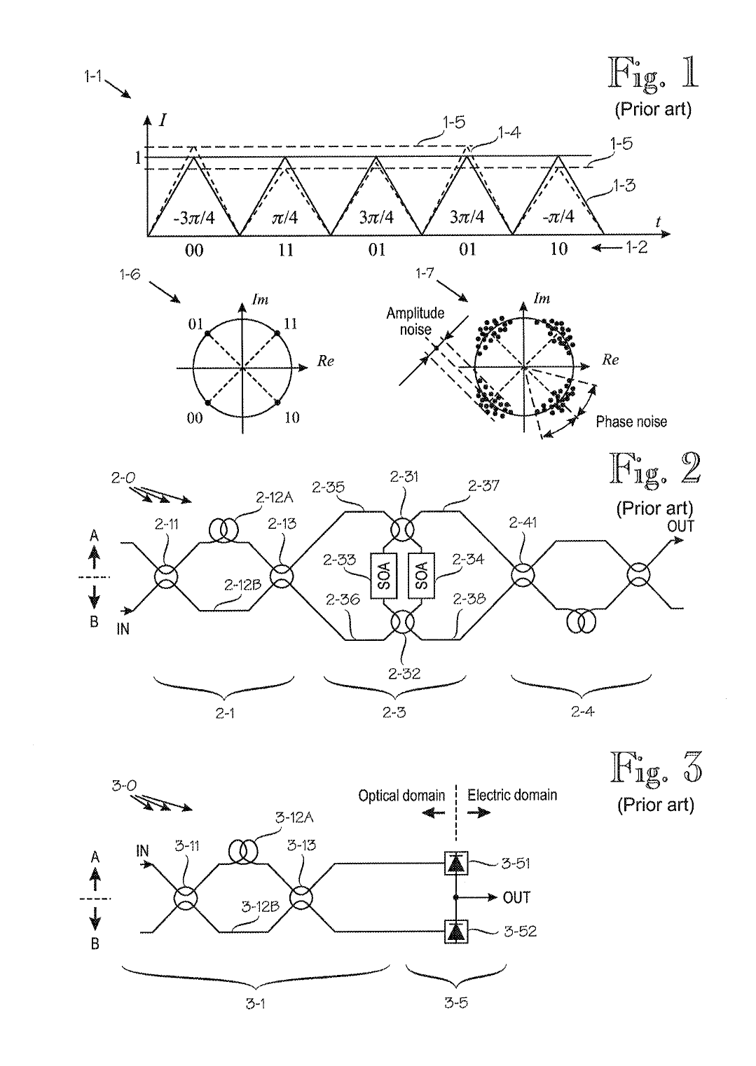

### DETAILED DESCRIPTION OF SPECIFIC EMBODIMENTS

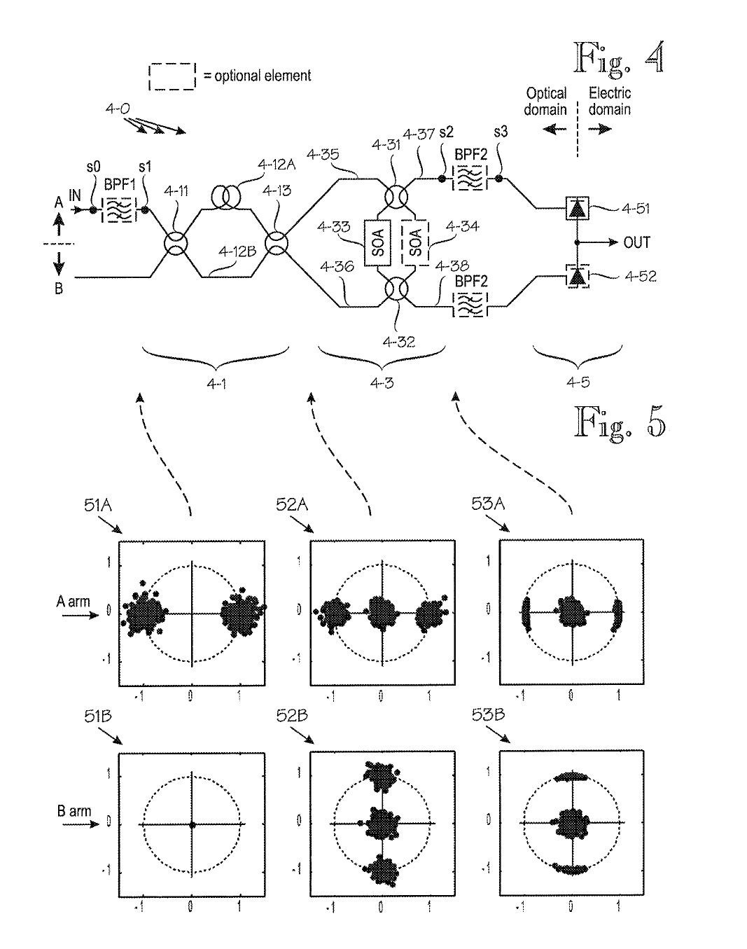

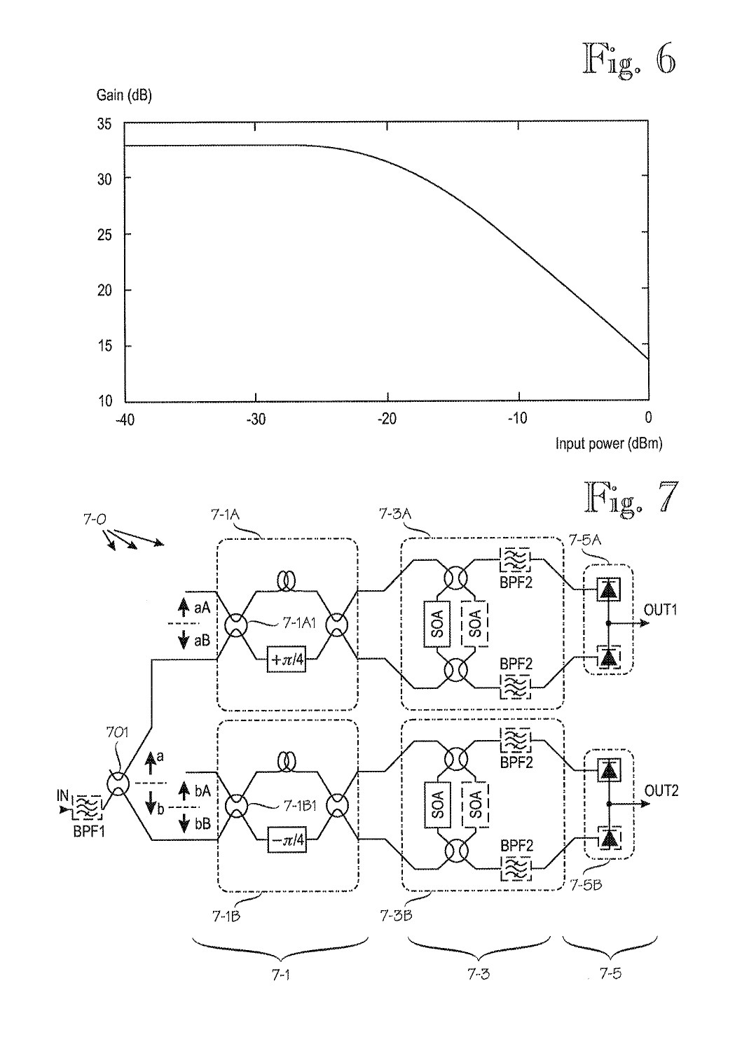

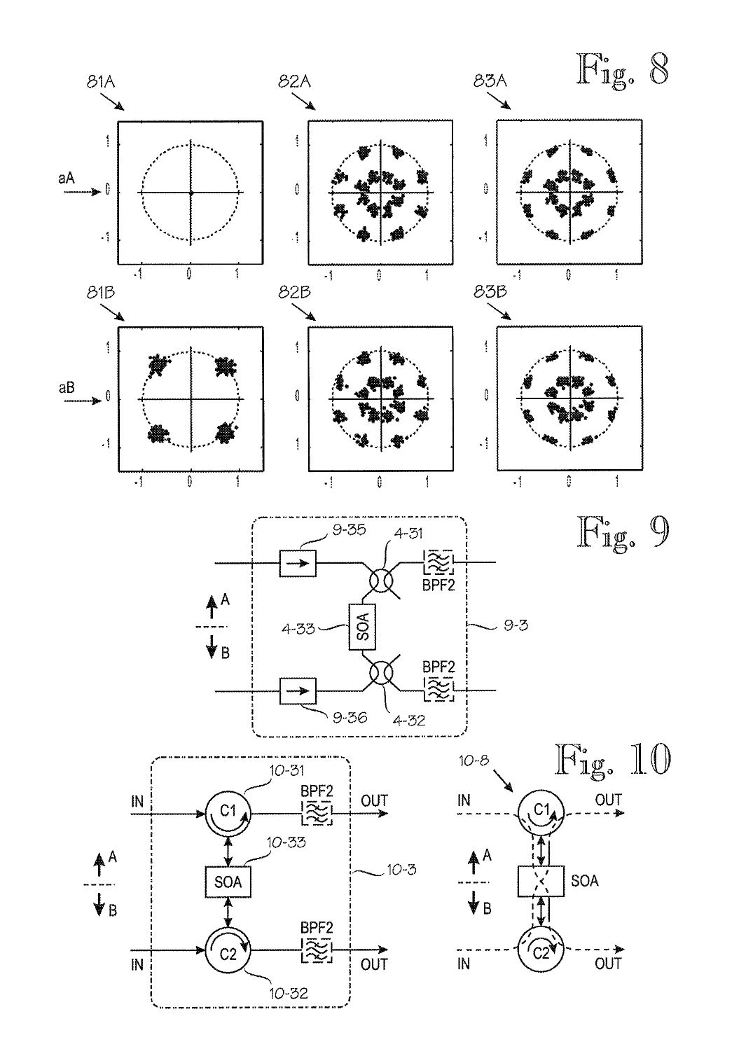

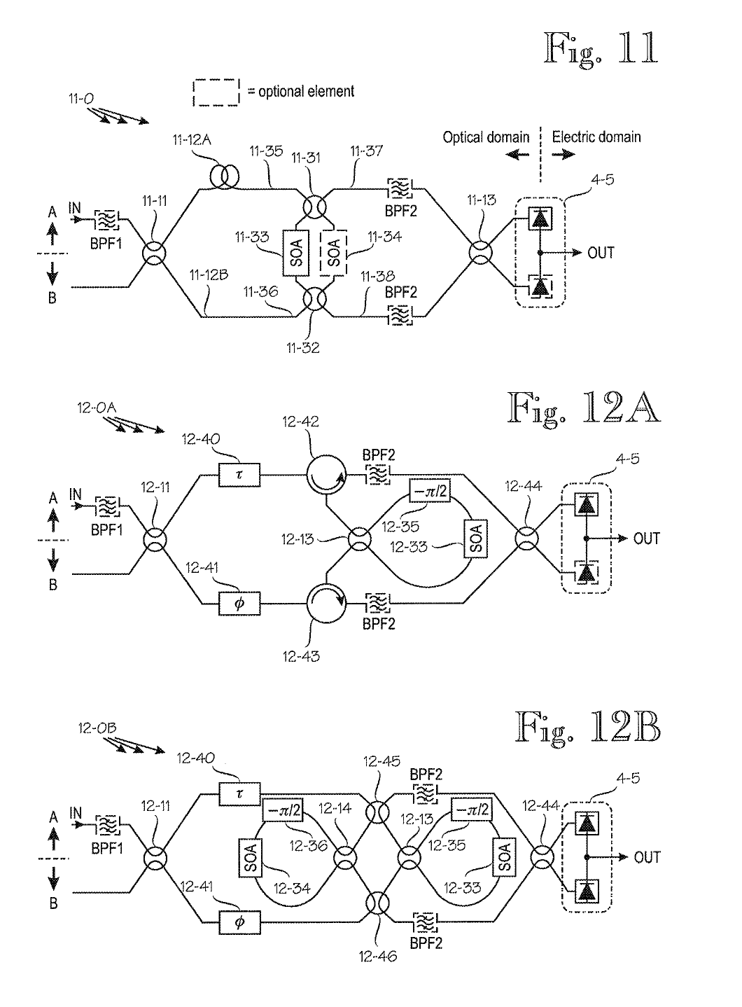

FIG. 4 shows an embodiment of the present invention, denoted by reference numeral 4-0. This embodiment comprises three major sections, which are a modulation conversion stage 4-1, a regeneration stage 4-3 and a photo-electric conversion stage 4-5. The modulation conversion stage 4-1 receives an optical input signal carrying symbols in a first modulation format which is at least partially phase-modulated such that each symbol has a unique nominal phase value. It converts the symbols in the first modulation format to symbols in a second modulation format which is a phase/amplitude-modulation format such that each symbol has a unique combination of nominal phase value and nominal amplitude. In the present embodiment, the modulation conversion stage 4-1 is implemented as a delay interferometer, which can be similar to the delay interferometers 2-1 and 3-1 described in connection with FIGS. 2 and 3, and a detailed description is omitted.

The regeneration stage 4-3 resembles the amplitude regeneration stage 2-3 of the known regenerator 2-0. As a departure from the prior art, the regeneration stage 4-3 is logically positioned between the optical receiver's modulation conversion stage 4-1, such as a delay interferometer, and the photo-electric conversion stage 4-5. Another departure from the prior art is that the regeneration stage 4-3 is not followed by a 3 dB coupler, such as the coupler 2-41 in FIG. 2. Instead, the optical paths A and B from the regeneration stage 4-3 are directed to the photo-electric conversion stage 4-5 without further coupling between the optical paths A and B. According to the teaching of reference document 4, an optional first bandpass filter BPF1 may be installed for filtering the optical input signal IN, in which case a pair of second bandpass filters BPF2 is installed at some points along the sections of the optical paths denoted by reference numerals 4-37 and 4-38. The band pass of the first filter BPF1 differs from that of the second filters BPF2, as stated in the introductory section of this document.

The inventors have discovered that the regeneration stage 4-3 can be implemented with only one of the two SOA components 4-33 and 4-34, whereby the other SOA component can be omitted. This issue will be discussed in more detail in connection with FIGS. 9 and 10.

The circuit 4-0 operates as follows. The delay interferometer 4-1 converts the phase modulated signal (for instance DPSK) to a modulation format which is partially phase modulated and partially amplitude modulated. A pair of consecutive input signals is converted into a pair of high-level and low-level amplitude signals. In case of a noiseless input, the low-level signal intensity is zero. The amplitude and the phase noise are both superimposed on the high and low levels of the optical signal. Depending on the phase difference of the consecutive symbols, the high-level amplitude signal propagates either along the A optical path or the B optical path. When the high-level and low-level signals meet in a nonlinear amplifying element, such as the semiconductor optical amplifier (SOA) 4-33, 4-34, the high-level signal saturates the medium, which results in suppression of the amplitude variation of the high-level signal. The low-level signal experiences the same transmission characteristics as the high-level signal, because both the low-level and the high-level signal are present in the SOA component and propagate through it simultaneously. As a result, both signals experience the same gain, and the amplitude of the noise in the low-level signal is either suppressed or enhanced. The effect of the limiting amplifier is such that the “signal eye” widens because the noise of the high-level signal is suppressed while the statistical distribution, such as the standard deviation, of the low-level signal remains almost constant. As used herein, the signal eye means a gap between low-level noise and high-level noise. It is thus a measure of signal quality. The widening of the signal eye primarily results from the noise of the high-level signal is efficiently suppressed.

In addition to the nonlinear amplification, the one or two nonlinear amplifying elements 4-33, 4-34 may further induce self-phase modulation (SPM) and/or spectral shifting onto the through propagating high- and low-level signals. As discussed in reference document 5, the transmission functions of the SPM broadened high- and low-level signals are different from one another when directed through suitable bandpass filters. This results in further widening of the signal eye. In following text the process of noise suppression due to SPM and/or spectral shifting of the bandpass filtered signals, as discussed in reference documents 4 and 5 and as explained above, is called “Mamyshev regeneration”.

Provided that the optional bandpass filters BPF1, BPF2 are installed, the embodiment shown in FIG. 4 implements Mamyshev regeneration in such a manner that a first bandpass filter BPF1 improves signal-to-noise ratio of the optical signal by passing the signal (and noise) at the filter's transmission band while blocking other parts of the optical spectrum. The noisy amplitude-modulated signal is directed into the nonlinear regenerator, namely the SOA component(s) 4-33, 4-34, which broaden the spectrum of the optical signal by means of self-phase modulation. The self-phase modulation may also cause shifting of the signal spectrum to a lower frequency, ie, red-shifting of the signal. In addition, the spectrum of the counter propagating noise signal may also be shifted, now to a higher frequency. It is thus blue-shifted. After the SOA component(s) 4-33, 4-34, the spectrally broadened and red-shifted signal is directed to a second bandpass filter, implemented as a pair of filters denoted by reference signs BPF2, that transmits only parts of the spectrally broadened and/or shifted signal. For instance, the second bandpass filter BPF2 may transmit parts of the broadened and red-shifted signal spectrum, but block, at least partially, the original signal band filtered by the first bandpass filter BPF1. Noise at the pass band of the first bandpass filter BPF1 and the noise at the possibly blue-shifted frequencies are thus suppressed and the signal is regenerated. On the other hand, noise suppression can also be implemented such that the second bandpass filter BPF2 has the same transmission wavelength as the first bandpass filter BPF1 and the second bandpass filter BPF2 transmits only parts of the broadened and/or shifted signal spectrum. Reference signs s0 and s1 respectively denote the input and output signals of the first bandpass filter BPF1, while reference signs s2 and s3 denote the input and output signals of the second bandpass filter BPF2. The effect of the optional Mamyshev regeneration implemented by means of the bandpass filters BPF1, BPF2 will be further described in connection with FIG. 18, which illustrates power spectra of the signals s0 through s3.

It was stated earlier, in connection with the description of the prior art, that a straightforward technique for reducing noise in an optical receiver 3-0 is regenerating the optical signal by a regeneration apparatus 2-0 as taught by reference document 1, prior to applying the optical signal to the optical receiver 3-0. The inventors of the present invention have found out that this straightforward technique fails to provide the optimal noise suppression characteristics, for the following reason. Assuming that the incoming optical signal power saturates the SOA, its output will indeed suppress the amplitude variation by the effect of limiting amplification. However, the saturated SOA also affects the phase of the optical signal. If two consecutive symbols of the input signal have different amplitudes, the phase difference of these two signals will also be changed. The delay interferometer transforms such phase variation to an amplitude variation, which results in increased amplitude noise at the output of the delay interferometer, thus compromising the performance of the regenerator. This also applies to a single SOA positioned in front of an optical phase-sensitive receiver. Because of pulse-to-pulse amplitude variation, the phase is also varied, which will again be translated into amplitude variation at the output of a delay interferometer.

Reference document 1 teaches that the circuit 2-0, which is a sequence of a first delay interferometer 2-1, a limiting semiconductor optical amplifier (SOA) 2-3, and a second delay interferometer 2-4, has an ability to remove amplitude and phase noise. This is true to certain extent, but there are two drawbacks when using the second delay interferometer 2-4. As explained in the preceding paragraph, a saturated SOA alters the phase of the optical signal. Although the limiting amplifier suppresses amplitude noise, it simultaneously generates parasitic (unwanted) symbol-to-symbol variations in the signal phase. After the limiting SOA amplifier, when two consecutive symbols are combined in the second delay interferometer 2-4, this phase variation is translated into amplitude noise, thus degrading performance, which is one of the drawbacks. The second drawback is that the receiver 3-0 will require yet another delay interferometer 3-1 before the amplitude detection stage 3-5, because the second delay interferometer 2-4 transforms the phase/amplitude modulated signal back to a phase-only-modulated signal, and the amplitude detection stage 3-5 cannot detect information in the phase-only-modulated signal.

The second delay interferometer's undesired tendency to generate additional amplitude noise can be circumnavigated by connecting both the A and B arms of the output of the second delay interferometer 2-4 to the respective A and B arms of the input of the third delay interferometer 3-1 (as opposed to the conventional technique of connecting only one output, such as the “OUT” terminal of the regenerator 2-0 to the respective input “IN” of the receiver 3-0). This work-around effectively restores the signal to the modulation format and state it had before the second delay interferometer 2-4. It should be noted, however, that such an arrangement increases expenses and the corresponding teaching is not provided in above-mentioned reference documents.

The photo-electric conversion stage 4-5 typically uses the electrical output signal of the two photodetectors 4-51, 4-52 in a balanced receiver configuration which outputs a single electrical signal as a difference of the two photodetectors' electrical output signals. As is known in the art, in an ideal case the signal from either photodetector alone contains all the information, but a photodetector pair in a balanced receiver configuration is typically used for improved noise tolerance. Some embodiments of the invention only employ a single photodetector, which is installed in either of the optical output arms, and which directly converts the optical signal into an electrical signal. As a result of the noise suppression provided by the regeneration stage 4-3, use of two photodetectors in a balanced receiver configuration may not be required. Accordingly, each pair of photodetectors in a balanced receiver configuration may be replaced by a single photodetector.

In FIG. 4, one of the two photodetectors 4-51, 4-52 is shown as mandatory while the other is shown as optional. The mandatory status of at least one photodetector means that conversion of the optical signal to an electrical signal must take place somewhere logically after the inventive regeneration mechanism, but such photo detection can take place in an optical receiver which may be separate from the inventive regeneration mechanism, as will be further described in connection with FIG. 19. This applies to all embodiments shown with a photo detection stage.

FIG. 5 is a set of constellation diagrams which further explain the operating principle of the embodiment shown in FIG. 4 in connection with DPSK modulation. There are 6 constellation diagrams 51A to 53A and 51B to 53B. Reference signs ending in A or B relate, respectively, to the signal arms labelled A and B. Reference signs 51A and 51B denote constellation diagrams at the A and B arm inputs of the circuit 4-0. Reference signs 52A and 52B denote constellation diagrams at the A and B arms after the delay interferometer 4-1, which acts as a modulation format conversion stage. Reference signs 53A and 53B denote constellation diagrams at the A and B arms after the regeneration stage 4-3, without the Mamyshev regeneration.

Diagram 51A, which relates to the A arm input to the circuit 4-0, describes a DPSK modulated input signal having both phase noise and amplitude noise. Since nothing is connected to the B arm input, the diagram 51B is a zero signal. Diagrams 52A and 52B describe the A and B arm signals after the delay interferometer 4-1, both of which exhibit high-level and low-level signals, both containing phase noise and amplitude noise. The high-level signals and low-level signals appear as pairs, such that the delay interferometer's one output produces the high-level signal and the other output produces the low-level signal, and the regeneration stage 4-3, such as the limiting SOA amplifier, always processes the optical signal as symbol pairs, because the regeneration is based on the simultaneous occurrence of the symbols in the SOA.

FIG. 6 shows the gain (transmission) curve of a typical nonlinear semiconductor optical amplifier. The gain remains constant at low input power levels but saturates at high power levels. Optical power is proportional to the square of a complex amplitude: P=|A|²=AA*, wherein A* is the complex conjugate of A. Thus the gain decreases with increasing input power level. This means that the output power may even stay constant regardless the input power in the saturation region. In a representative amplifier, the gain for input power of −10 dBm is 23.5 dB (−10 dBm+23.5 dB=13.5 dBm), while for input power of −5 dBm it is 18.5 dB (−5 dBm+18.5 dB=13.5 dBm). The output power is thus 13.5 dBm for both cases, which means that power variation at the amplifier's output is suppressed.

The ability of the SOA component to suppress input power variations in the saturation region of the gain curve is manifested in the constellation diagrams 53A and 53B of FIG. 5, which show that the amplitude variation of the high-level signals after the regeneration stage 4-3 is very much diminished. Phase variation, which is represented by the low-level noise at the center of the constellation diagram and by the radial spreading of the high-level signals, remains largely intact. It will be seen that the low-level noise spread has not been reduced, nor has it been increased. This is because the low-level and high-level signals meet in the nonlinear medium at the same time and thus the low-level signals are amplified only to the same degree as the high-level signals. The normalized standard deviation of the power spread of the low-level noise remains nearly unchanged. In the present embodiment, neither the high-level signals nor the low-level signals are attenuated because the gain is typically higher than one. However, the statistical relative (normalized) noise level of the high-level distribution is compressed by the limiting-amplifier effect. Had this colliding signal scheme not been used, the low-level signals would have obtained higher gains. For example, if the high-level input signal power is −10 dBm and the low-level input noise signal power is −30 dBm, then the high-level signal will obtain gain of 23.5 dB, while the low-level signal without the colliding scheme will have gain of 33 dB. The low-level signal will thus obtain +9.5 dB more gain than it would in case of colliding pulse limiting amplification. Should the Mamyshev regeneration be employed in addition to the limiting amplification, which involves the addition of the first bandpass filter BPF1 and the second bandpass filters BPF2 as well as the SPM and/or red-shift process of the limiting amplifier, the relative noise level of the low-level signal can be further diminished. That is, the spread of the high-level signals and low-level signals can be reduced.

In experiments and simulations carried out by the inventors, a typical Q-value improvement without Mamyshev regeneration was about 3 dB at a wavelength of 1550.12 nm, input power range of −10 dBm to +5 dBm, and for input Q-value range of 2-15 dB. As used herein, the Q-value is defined as Q=10 log(Δ/(σ1+σ0)), wherein Δ is the measured average power difference of high-level and low-level signals, and σ1 and σ0 are the power standard deviations (noise) of high-level and low-level signals, respectively.

FIG. 7 shows a DQPSK receiver 7-0 which is enhanced according to the teaching of the present invention. The DQPSK receiver 7-0 comprises a first 3 dB coupler 701, which splits the signal applied to the input IN into two optical paths a and b. Each of the optical paths a, b is applied to a respective delay interferometer 7-1A and 7-1B, which act as modulation conversion stages. The delay interferometers 7-1A and 7-1B comprise respective couplers 7-1A1 and 7-1B1, which again split each of the optical paths a and b to two further optical paths aA, aB and bA, bB. Each pair of the optical paths (aA, aB) and (bA, bB) generally corresponds to the A and B paths of the circuit 4-0, and the processing of the optical signals within either pair of arms is almost similar to the processing described in connection with FIG. 4, whereby a complete description is superfluous. However, the delay interferometers 7-1A and 7-1B of the present embodiment differ from the interferometer 4-1 described earlier in that the delay interferometers 7-1A and 7-1B exhibit mutually different relative phase shifts. In the present example, the relative phase shifts are +π/4 and −π/4 radians.

The delay interferometers 7-1A and 7-1B are followed by respective regeneration stages 7-3A and 7-3B. These are followed by respective photoelectric conversion stages 7-5A, 7-5B, which are again implemented as photodiode pairs, or as individual photodiodes, similarly to the corresponding element 4-5 in FIG. 4.

The fact that the delay interferometers 7-1A and 7-1B exhibit mutually different phase shifts, such as +π/4 and −π/4 radians as in the present example, can be considered surprising. This is because the outputs of the delay interferometers 7-1A and 7-1B do not exhibit the high-level and low-level signals in the sense of DPSK modulation, where the low-level signal approaches zero in case of noiseless input. Instead, the output of the interferometers 7-1A and 7-1B exhibit normalized amplitude values of 0.92 and 0.38 (or respectively power values of 0.85 and 0.15, because cos [(π/4)/2]=0.92 and sin [(π/4)/2]=0.38; the squares of which are 0.85 and 0.15, respectively). These signal levels can be called high-level and low-level signals although their precise numerical values differ from those used in connection with BPSK modulation.

FIG. 8 is a set of six constellation diagrams, which further explain the operating principle of the embodiment shown in FIG. 7 in connection with DQPSK modulation. All of the constellation diagrams 81A through 83B relate to the arm denoted “a”, which exhibits the +π/4 relative phase shift. The arrangement of the constellation diagrams shown in FIG. 8 is analogous to those shown in FIG. 5, and reference signs ending in A or B relate, respectively, to the signal arms labelled aA and aB. Constellation diagrams 81A and 81B appear at the aA and aB inputs of the delay interferometer 7-1A. Constellation diagrams 82A and 82B appear at the aA and aB arms after the delay interferometer 7-1A, while the last pair of constellation diagrams 83A and 83B appear at the aA and aB arms after the regeneration stages 7-3A, ignoring the Mamyshev regeneration. If the Mamyshev regeneration were employed, the high-level and low-level signal amplitudes 83A, 83B would be further suppressed.

It can be seen that the DQPSK modulated signal is transformed to a phase/amplitude modulated signal having two distinctive amplitude levels. (In case of a φ=0 delay interferometer, there would be three amplitude levels.) After the limiting amplification there is some improvement at both levels, such that the Q value of the received signal is improved. A further improvement can be obtained if the optional first bandpass filter BPF1 and second bandpass filters BPF2 are employed and when the limiting amplifier induces SPM broadening and/or frequency shifting into the signal spectra. Contrary to the teaching of reference 1, limiting amplification alone, or optionally combined with Mamyshev regeneration, is sufficient for signal improvement. It must be noted, however, that discriminative gain does not harm the operation of the invention.

Actual measurements were carried out using an amplifying medium exhibiting the gain curve shown in FIG. 6. When two signal propagating in opposite directions collide in the amplifying medium, the gain of the limiting amplifying medium is determined by the combined net power of the two colliding signals. Both high-level signals and low-level signals experience the same gain. Assuming that the power levels of the colliding signals are 0.85 mW and 0.15 mW, for example, the gain of the amplifying medium is determined by the combined net power, which is 1 mW (0 dBm). Both signals experience the same gain, which is 13.5 dB for a power level of 0 dBm and the amplifying medium described in FIG. 6. As long as the combined optical power of the colliding signals remains in the saturation region, the saturating gain of the amplifying medium suppresses amplitude variations regardless of the power level of the signal. High-level signals experience stronger suppression than low-level signals do, but the standard deviations of both levels are somewhat reduced, as indicated by the constellation diagrams shown in FIG. 8.

FIGS. 9 and 10 illustrate alternative construction implementations for the regeneration stage. FIG. 9 shows an alternative regeneration stage 9-3 which, similarly to the regeneration stages 4-3, 7-3A and 7-3B described earlier, is configured to regenerate optical signals propagating via two optical paths generally denoted A and B. The regeneration stage 9-3 comprises two couplers 4-31 and 4-32, and a semiconductor optical amplifier, SOA, denoted by reference numeral 4-33, which provide a coupling between the optical paths A and B. The regeneration stage may further contain second optical bandpass filters BPF2 for Mamyshev regeneration. The regeneration stage 9-3 differs from the previously-described ones in that there is only one SOA component. Omission of the other SOA component causes a 6 dB loss in signal power, but this can be tolerated in some implementations or compensated for by amplifier gain in others. In addition to the possible 6 dB signal amplitude loss, elimination of one SOA component from a supposedly symmetrical pair of SOA components disrupts circuit symmetry, which causes reflection of one half of the signal power back towards the preceding stages. Such asymmetric embodiments may benefit from the addition of optical isolators in either optical path A and B. Such optical isolators can be installed in front of the coupled nonlinear element or in any preceding stage of the optical system. In FIG. 9, reference numerals 9-35 and 9-36 denote such optical isolators. The regeneration stage 9-3 can be substituted for the regeneration stages 4-3, 7-3A and 7-3B shown in FIGS. 4 and 7.

FIG. 10 shows yet another regeneration stage 10-3, which is based on the same idea as the regeneration stage 9-3 shown in FIG. 9. In the regeneration stage 10-3, an optical circulator C1, C2 has been substituted for each pair of optical isolator and coupler. Specifically, the A arm input is coupled to a first port of first circulator 10-31, whose second port is coupled to an SOA component 10-33. The third port of the first circulator 10-31 forms the A arm output of the regeneration stage 10-3. The B arm, which comprises second circulator 10-32 is symmetrical with the A arm. Reference numeral 10-8 is a diagram in which dashed lines depict propagation of optical signals within the regeneration stage 10-3. The optical signal applied to the A arm input is directed from the first circulator C1 via the SOA to the second circulator C2, from which it is directed to the B arm output of the regeneration stage 10-3. As the regeneration stage 10-3 is symmetrical, the optical signal applied to the B arm input is directed from the second circulator C2 via the SOA to the first circulator C1, from which it is directed to the A arm output of the regeneration stage 10-3. As discussed in connection with FIG. 9, the regeneration stage 10-3 may also contain the bandpass filters for the Mamyshev regeneration.

The isolators 9-35, 9-36, and circulators 10-31, 10-32 shown in FIGS. 9 and 10 address a residual problem, namely unwanted reflection of signal energy back towards the preceding optical elements. Such reflection might otherwise damage the preceding optical elements or at least disturb their operation. Another source of unwanted reflection is parasitic reflections from photodiodes, optical connectors or splices between optical elements, such as delay interferometers or couplers, or from any other optical components or elements of the transmission system. These reflections in conjunction with the optical amplification may disturb the operation of the limiting amplifier and the photo detectors. Within the embodiments shown in FIGS. 9 and 10, the optical isolators and/or circulators reduce or eliminate such unwanted reflection of signal energy back towards the preceding optical elements.

The embodiments described in connection with FIGS. 4 and 7 each comprise a clearly demarcated modulation conversion stage, regeneration stage and photo detector stage. The invention is not restricted to such embodiments, however, and FIG. 11 shows an embodiment for DPSK operation, in which the amplitude regenerator is located within the delay interferometer, which in the preceding embodiments is an illustrative example of the modulation conversion stage. In the circuit 11-0 shown in FIG. 11, the delay interferometer consists of the first coupler 11-11, second coupler 11-13 and the two optical paths with unequal lengths, as denoted by reference numerals 11-12A and 11-12B. The reference numerals used in FIG. 11 are arranged such that item 11-nn of FIG. 11 corresponds to item 4-nn of FIG. 4, whereby a detailed description is superfluous. The amplitude regenerator of the circuit 11-0 is formed by couplers 11-31 and 11-32 as well as the SOA components 11-33 and 11-34, one of which is optional, as stated in connection with the previous embodiments. The amplitude regenerator is clearly located between the first and second couplers 11-11, 11-13 of the delay interferometer. The circuit 11-0 is terminated into a photo detector stage 4-5, similarly to the previous embodiments. As stated in connection with FIG. 9, optical isolators may be useful in reducing unwanted reflections, particularly in embodiment employing a single SOA component. Mamyshev regeneration may additionally be employed by installing the first bandpass filter BPF1 to the input of the circuit 11-0 and the second bandpass filters BPF2 after the limiting amplifier. The limiting amplifier 11-33, 11-34 should also induce SPM and/or frequency shifting into the signals, as explained earlier.

Operation of the circuit 11-0 differs from the previous embodiments in that the one or more limiting amplifiers 11-33, 11-34 perform amplitude regeneration while the optical signal is in its first modulation format, in which useful information is conveyed by modulating at least one physical parameter other than amplitude. The optical signal is not converted to the second modulation format until the second coupler 11-13, which in the present embodiment is followed by the photo detector stage 4-5 without any intervening conversion or regeneration elements. A difference to the previous employments of Mamyshev regeneration is that now the spectrally broadened and/or frequency-shifted signal does not have high-level signals and low-level signals. Instead, both spectrally broadened and/or frequency-shifted signals are in the first modulation format. When properly employed, the Mamyshev regeneration is known to remove noise, and particularly ASE noise (ASE=amplified spontaneous emission) of the signal.

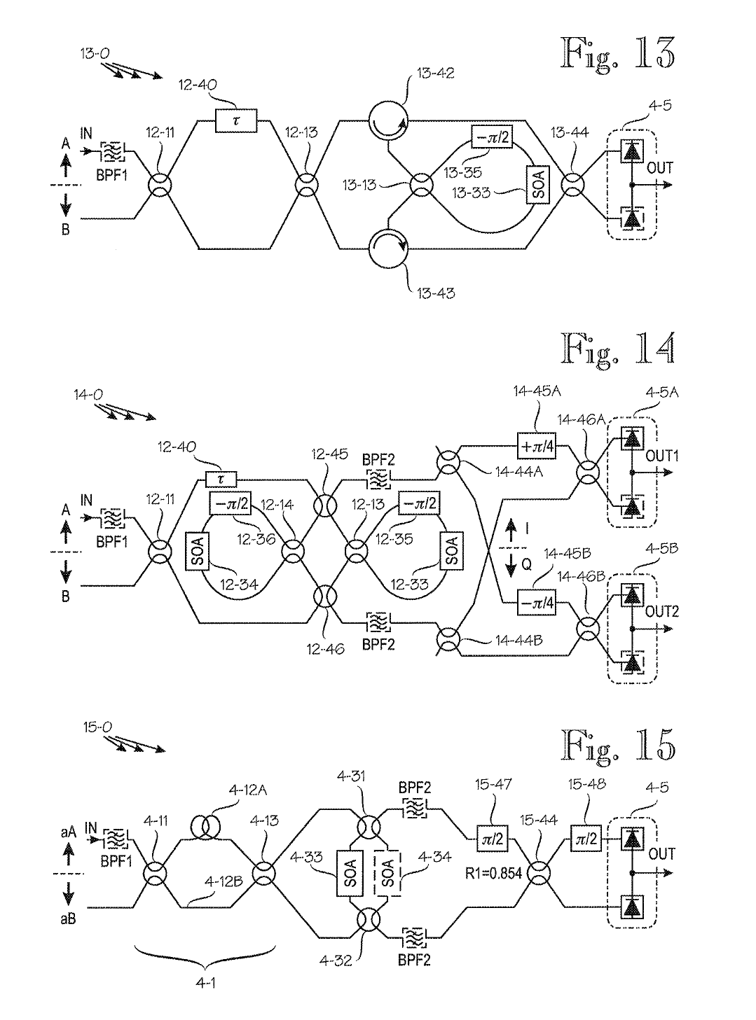

FIGS. 12A, 12B and 13 show embodiments which are particularly insensitive to internal reflections within the SOA components. FIG. 12A shows a circuit 12-0A, in which a delay interferometer is formed by a first coupler 12-11 and a second coupler 12-13. The A arm of the delay interferometer comprises a delay line 12-40, which causes a temporal difference of one symbol period between the A and B arms. The B arm comprises a phase control element or phase shifter 12-41, which can be adjusted to cause a relative phase difference of zero for DPSK operation or ±π/4 radians for DQPSK operation, in which case the apparatus comprises two circuits 12-0A in parallel, one for the I channel and the other for the Q channel, and the relative phase difference between the channels ±π/2 radians. From the A and B arms, the optical signals are directed to the second coupler 12-13 by respective circulators 12-42, 1243. The two output ports of the second coupler 12-13, namely the two ports farthest away from the first coupler 12-11, are coupled to one another via a Sagnac loop, which is formed by a SOA component 12-33 and a −π/2 (or +π/2) radian phase shifter 12-35. Whether the value −π/2 or +π/2 is applied depends on the phase shift intrinsically exhibited by the used couplers 12-13 and 12-44. Anyway, in practice the phase shifter will be optimized to another value than −π/2 or +π/2 depending on unbalanced arm lengths of the Sagnac loop (corresponding to FIG. 12A, upper and lower arm of the Sagnac loop between coupler 12-13 and SOA 12-33 are not equal, or both arm lengths corresponding to the location of the reflection are not symmetrical). In practice the device can be measured once, then the phase shifter value can be set accordingly to a fixed driver voltage, current or temperature (later no adaptive changes due to environmental temperature drifts will be needed as the arm length asymmetry is very small and robust).

Assuming that phase is the physical parameter being modulated, the optical signal exiting from the output port of the second coupler 12-13 to the Sagnac loop 12-33, 12-35, is phase/amplitude modulated having high-level pulses and low-level pulses. These pulses propagate along the Sagnac loop and collide with one another in the SOA 12-33. After circulating through the loop, the pulses re-enter the coupler 12-13, which splits them to the A and B arms via the circulators 12-42, 12-43. Thereafter the A and B arm signals are directed to a third coupler 12-44. The second and third couplers 12-13, 12-44 form a Mach-Zehnder interferometer, whose output is again phase/amplitude modulated. The optical signals are terminated into a photo detector stage 4-5 without any intervening conversion or regeneration elements. Mamyshev regeneration can be included by introducing the first bandpass filter BPF1 and the second bandpass filters BPF2, and by ensuring that the limiting amplification provides the needed SPM into the signal. The bandpass filters BPF2 can be located after the circulators 12-42, 12-43, or in one or both output arms of the 3 dB coupler 12-44.

The insensitivity to internal reflections arises from the following reason. Signals that first enter the Sagnac loop from outside, then counter-propagate through the full loop, and then exit the loop, are treated differently from signals that do not make a full roundtrip in the loop. Internal reflections within the Sagnac loop do not make a complete roundtrip, thus they do not follow the strict symmetrical operation that is the basic Sagnac principle for signals entering the loop from outside. In general, parasitic reflections are exhibited by SOA facets. Internal SOA chip facets at the transition from the SOA chip to waveguide, fiber or free-space optical elements is a special problem that cannot be influenced by external engineering solutions. In implementations without the Sagnac configuration, strong parasitic reflections cause interference between the high-level pulses and low-level pulses, and this interference can disturb circuit operation and reduce noise-suppression efficiency. The Sagnac configuration described in connection with FIGS. 12A, 12B and 13 redirects the reflected signals from the high-level signal to the original high-level signal and the reflected signals from the low-level signal to the original low-level signal. As a result, reflection-induced disturbances are reduced or eliminated altogether.

The operating principle of sending the parasitic reflections to the output ports where they do not interfere with the other signal (such as low-level signals with high-level signals or vice versa) is based on balancing of the Sagnac loop's arm lengths on either side of the SOA, which is located at the midpoint of the loop. As usual, the arms can be realized as waveguides, optical fibres or free space paths. An additional −π/2 (or +π/2) radian phase shift element 12-35 is needed within the loop. If the reflection facets are not positioned symmetrically to the center of the Sagnac loop, the phase shift element 12-35 needs to be adjusted to a phase shift value other than −π/2 (or +π/2). The more the reflection values on either side of the SOA are alike, the better is the loop's ability to suppress reflection-induced noise. Only the difference in reflection values causes residual disturbances, even if the absolute reflection value at the facets is high.

FIG. 12B shows an alternative embodiment for the circuit 12-0A shown in FIG. 12A. The embodiment denoted by reference numeral 12-0B differs from the one shown in FIG. 12A in that couplers 12-45 and 12-46 have been substituted for the circulators 12-42 and 12-43 used in the circuit 12-0A. As stated earlier, asymmetric single-SOA implementations suffer from unwanted reflections directed towards the preceding stages, unless circulators or optical isolators are being used. Accordingly the circuit 12-0B comprises a symmetric arrangement of two Sagnac loops, wherein one loop is formed by the coupler 12-13, SOA 12-33 and phase shift element 12-35 and the other loop is formed by mirrored counterparts of these elements, denoted by respective reference numerals 12-14, 12-34 and 12-36.

FIG. 13 shows an embodiment 13-0 in which a Sagnac loop formed by coupler 13-13, SOA 13-33 and phase shift element 13-35 is clearly separated from the delay interferometer formed between couplers 12-11 and 12-13.

FIG. 14 shows how the embodiment of FIG. 12B can be extended for DQPSK operation. In the circuit 14-0 shown in FIG. 14, all items having reference numerals 12-nn can be identical with their counterparts shown in FIG. 12B, and such items will be not described again. Instead of a single third coupler, like the coupler 12-44 in FIGS. 12A and 12B, the circuit 14-0 comprises a pair of third couplers 14-44A, 14-44B, which divide the optical signal into I and Q channels. Phase shift elements 14-45A, 14-45B cause a relative π/2 radian phase difference between the I and Q channels.

The Sagnac loop arrangement of the circuit 14-0 is identical with that of the circuit 12-0B shown in FIG. 12B, although the circuit 12-0B is designed for DPSK operation and the circuit 14-0 for DQPSK operation. Noise suppression of high-level signals is performed independently from the modulation format conversion, which takes place in the delay interferometer terminated at the pair of couplers 12-13 and 12-14. This means that noise suppression is performed for pairs of low-level symbols and high-level symbols as well as for a pair of symbols at −3 dB level.

The embodiments of FIG. 12A and FIG. 12B fulfil an identical basic functionality. The use of circulators in FIG. 12A instead of 3 dB couplers in FIG. 12B allows for using only one limiting amplifier stage (in the following, one Sagnac loop with one SOA and one phase shift element inside as shown in FIG. 12A is called one “Sagnac-SOA stage” or “single Sagnac-SOA stage”) instead of two Sagnac-SOA stages (or “double Sagnac SOA stage”) without changing the basic functionality of the entire device. The circulators fulfil an additional effect of blocking reflected signals of the outer parts of the entire device (outside the Sagnac-SOA stage) as already described in connection of FIG. 10. A further possible embodiment with only one Sagnac-SOA stage can be similar to FIG. 12A, but by replacing both circulators by 3 dB couplers, i.e. by replacing each of the two circulators against a 3 dB coupler as shown by FIGS. 10 and 9.

FIG. 12B and FIG. 14 show the application with a double Sagnac-SOA stage for DPSK (FIG. 12B) and DQPSK (FIG. 14). In the same way as already described before, in both FIGS. 12B and 14, the double Sagnac-SOA stage can be replaced by a single-Sagnac-SOA stage.

FIG. 12B and FIG. 14 illustrate that the left part of the described invention, (left from coupler 12-44 in FIG. 12B) can be used unchanged for both applications, DPSK or DQPSK.

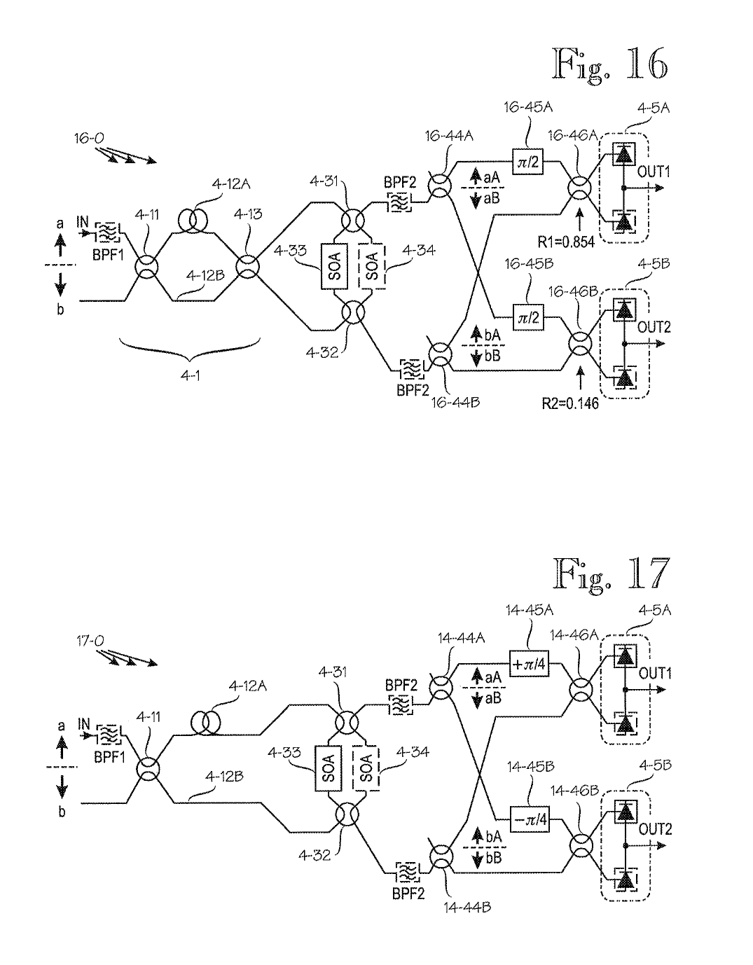

FIGS. 15, 16 and 17 are yet other embodiments for DQPSK operation. FIG. 15 shows how the embodiment of FIG. 4 can be extended for DQPSK operation. The DQPSK receiver (I- or Q-arm) 15-0 comprises a delay interferometer 4-1, which acts as a modulation conversion stage. The delay interferometer 4-1 comprises a respective coupler 4-11, which again splits the optical path denoted “a” into two further optical paths aA and aB. The optical paths aA, aB generally correspond to the A paths of the circuit 4-0, and the processing of the optical signals within either pair of arms is almost similar to the processing described in connection with FIG. 4, whereby a complete description is superfluous. While the first delay interferometer of the first modulation conversion means 4-1 has a relative phase shift of 0 radians, the phase/amplitude modulated signal of the delay interferometer output has three nominal amplitude levels. In order to transform these levels into two amplitude levels of the conventional DQPSK receiver, the output of the regeneration stage 4-3 is coupled into a second modulation conversion means 15-3, which comprises a coupler R1 and phase control elements 15-47, 15-48. The coupling efficiency of the coupler R1 is 0.854, while the second DQPSK arm b (not shown) has a coupler R2 with an efficiency of 1−R1=0.146. The phase control elements 15-47, 15-48 adjust a π/2 phase difference between the aA and aB arms of the circuit 15-0. The phase control 15-48 can usually be omitted, because the output of the second phase conversion means is directed further into a photo detector stage. The circuit 15-0 may further perform a Mamyshev regeneration process by employing the usual first and second bandpass filters BPF1, BPF2, before the input and after the limiting amplifier, respectively provided that the limiting amplifier induces the needed SPM and/or frequency shifting into the signal.

FIG. 16 shows a DQPSK receiver 16-0 according to an embodiment of the present invention. The DQPSK receiver 16-0 comprises a modulation conversion stage 4-1, and a regeneration stage 4-3 described in connection with FIG. 4, whereby a complete description is superfluous. After the regenerator, both optical partial signals are split into two parts by 3 dB couplers 16-44A and 16-44B, so that these partial signals are divided into two parallel modulation conversion stages further comprising relative phase shifts 16-45A and 16-45B and two mutually different couplers 16-46A and 16-46B with respective cross-coupled power ratios of 0.854 and 0.146. In the present embodiment, the relative phase shifts for both 16-45A and 16-45B are +π/2 radians.

The two parallel modulation conversion stages are followed by respective photo-electric conversion stages 4-5A, 4-5B, which are again implemented similarly to the corresponding element 4-5 in FIG. 4. The modulation format in the two photoelectric conversion stages 4-5A, 4-5B is similar to that of the photoelectric conversion stages 7-5A, 7-5B in FIG. 7.

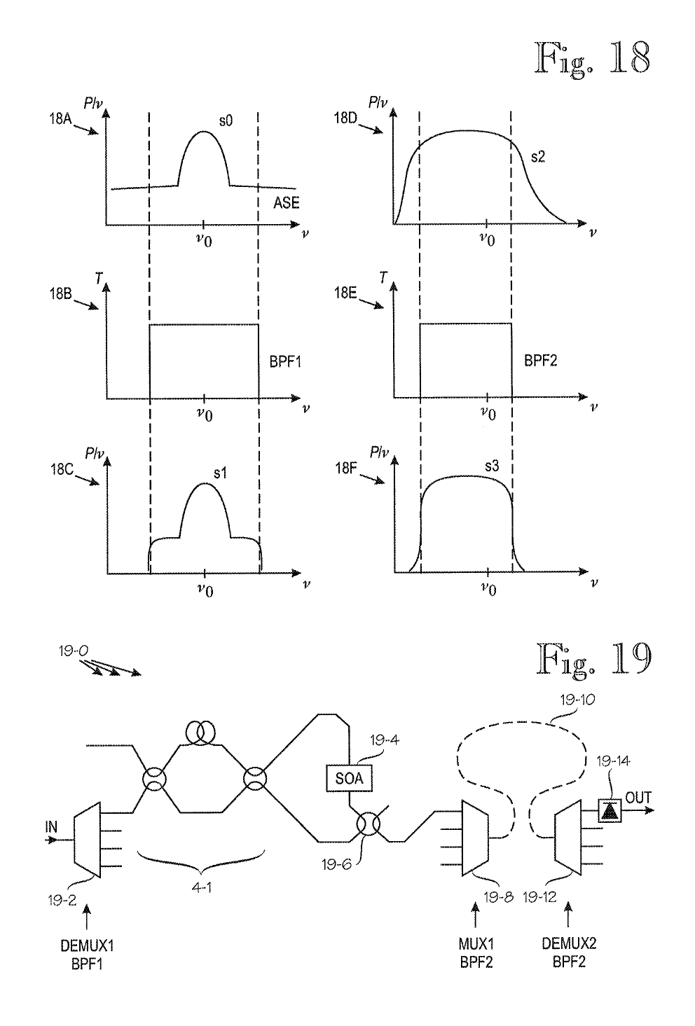

FIG. 17 shows an alternative implementation of the embodiment shown in FIG. 14. The circuit 17-0 is similar to circuit 14-0, apart from the fact that the limiting amplifier of the Sagnac loop is replaced with a pair of 3 dB couplers 4-31, 4-32, and SOA components 4-33, 4-32. Similarly to the circuit 16-0, the circuit 17-0 may also perform a Mamyshev regeneration process by employing the usual first and second bandpass filters BPF1, BPF2, before the input and after the limiting amplifier, respectively, provided that the limiting amplifier induces the needed SPM and/or frequency shifting into the signal. Couplers 14-44A, 14-44B and any elements after them have been described in connection with FIG. 14.

FIG. 18 further illustrates the Mamyshev regeneration according to an embodiment of the present invention. Reference signs 18A, 18C, 18D and 18F denote four different spectra, expressed as curves of power density Plv versus frequency v. The four different spectra relate to signals s0, s1, s2 and s3 which are shown in FIG. 4. The corresponding signals also exist in other embodiments although they are not explicitly shown in the drawings. Reference signs 18B and 18E denote, respectively, the transmission functions of the first and second band pass filter BPF1 and BPF2, expressed in terms of transmission T versus frequency v. Graph 18A depicts the spectrum of the input signal s0 which contains ASE noise (ASE=amplified spontaneous emission). The power density Plv has a peak at frequency v₀. Graph 18B depicts the transmission function of the first bandpass filter BPF1, whose pass band is centered around the frequency v₀, such that the signal spectrum s0 is transmitted, while a part of the ASE noise is suppressed. Graph 18C depicts the spectrum of the signal s1, which is generated from signal s0 by the first band pass filter BPF1. The signal s1 is directed to the nonlinear medium. Graph 18D depicts the spectrum (power density Plv versus frequency v) of the output signal s2 of the nonlinear medium, which in the illustrated example is both broadened and shifted in comparison with the input signal s1. Graph 18E depicts the transmission function T of the second bandpass filter BPF2, which transmits a part of the broadened and/or shifted signal spectrum s2 but rejects another part of the spectrum s2. Graph 18F depicts the spectrum of the output signal s3 of the second bandpass filter BPF2. The fact that the second band pass 18E of the second band pass filter BPF2 at least partially excludes the signal spectrum broadening and/or shifting is apparent by comparing the spectrum 18D first with the spectrum 18C and then with the spectrum 18F. Comparison of the spectra 18D and 18C indicate spectrum broadening and shifting by the nonlinear SOA amplifier. Comparison of the spectra 18F and 18D indicate that the spectrum broadening and shifting is excluded in spectrum portions outside the pass band 18E of the second band pass filter BPF2.

FIG. 19 shows how the invention can be embodied as an additional signal regenerator or noise suppression element, generally denoted by reference numeral 19-0, which is positioned in front of a conventional amplitude-sensitive optical receiver. Because the optical receiver may be entirely conventional, FIG. 19 only shows it in a very schematic manner, such that only a demultiplexer 19-12 and one channel-specific photo detector 19-14 are shown. The demultiplexer 19-12 separates the optical channels from one another, and each of the separated channels is directed to a channel-specific photo detection stage 19-14.

Reference numeral 19-0 generally denotes a signal regenerator or noise suppression element positioned in front of the optical receiver. The signal regenerator 19-0 comprises a demultiplexer 19-2, which separates the optical channels from one another, similarly to the multiplexer 19-12 of the optical receiver. For each channel, the signal regenerator 19-0 comprises a delay interferometer 4-1, a SOA component 19-4 and a 3 dB coupler 19-6. The SOA component 19-4 and the 3 dB coupler 19-6 generally correspond to respective elements 4-33 and 4-32, which were shown and described in connection with FIG. 4. The channels are multiplexed by a multiplexer 19-8, which in the present embodiment terminates the signal regenerator. The signal regenerator 19-0 can be coupled to the optical receiver via an optical connection 19-10, which may be up to several kilometres in length.

The arrangement shown in FIG. 19 can implement Mamyshev regeneration such that first demultiplexer 19-2 acts as the first bandpass filter (BPF1) of Mamyshev regeneration, while one or both of the first multiplexer 19-8 and the second demultiplexer 19-12 act as the second bandpass filter (BPF2) of Mamyshev regeneration. The delay interferometer 4-1 converts a DPSK signal into a partially amplitude modulated signal. The limiting amplification performed by the SOA 19-4 suppresses amplitude noise and possibly broadens and/or shifts the signal spectrum. The second bandpass filter embodied as the first multiplexer 19-8 and/or the second demultiplexer 19-12 blocks or rejects a portion of the broadened and/or shifted signal spectrum.

This arrangement is susceptible of variations. For instance, the elements 19-8 through 19-12, that is, the MUX1 and DEMUX2 plus the optical connection 19-10 can be replaced by an optical path, such as an optical fiber and, optionally, with a band pass filter which acts as the second band pass filter BPF2 of Mamyshev regeneration. This variation is applicable to conversion of DQPSK signal into two amplitude-modulated signals, whereby a DPSK regenerator as described in connection with FIG. 4 will be replaced by a DQPSK regenerator as described in connection with FIG. 7.

### Component Construction and Variations of the Described Embodiments

The above description of the various embodiments of the invention is not restricted to any particular implementation of the optical components. Instead the optical components, including but not limited to optical paths, delay elements, phase shifters, couplers, interferometers, saturable absorbers, nonlinear amplifiers, etc., can be constructed by means of any of the available technologies, including optical fibers, waveguides, free-space optical components (such as lenses, mirrors, or gratings), or some other types of optical path construction known to those skilled in the art, or any combinations of such technologies. The optical medium in the optical paths may include glass, such as silica; semiconductor, such as silicon; fluid, such as liquid, gas or gas mixture (eg air), or vacuum.

It is readily apparent to a person skilled in the art that the inventive concept can be implemented in various ways. The invention and its embodiments are not limited to the examples described above but may vary within the scope of the claims. Individual features from various embodiments can be used in combinations which are not described in the present document. For instance, FIGS. 12A and 12B show, respectively, asymmetric and symmetric Sagnac loop arrangements. These arrangements are mutually interchangeable. This teaching is also applicable to the embodiments shown in FIGS. 13 and 14.

While the terms QPSK and DQPSK imply encoding in which two symbol pairs are evenly distributed among the four quadrants of a circle, the invention is not restricted to such encoding schemes.

The invention is applicable to a variety of modulation formats, the reception of which involves comparison of two consecutive symbols with one another. The physical parameter being modulated may be phase, frequency or polarization state, or a combination of these parameters. The signal may be polarization multiplexed, ie, it may carry two streams of optical information in orthogonal polarization states, and the polarization demultiplexing may be performed after the limiting amplification. Alternatively or additionally the signal may be wavelength division multiplexed, ie, the delay interferometer and the limiting amplifier may process optical signals with more than one carrier wavelength simultaneously, such that the wavelength division demultiplexing is performed after the limiting amplification.

Phase shifting or a phase shifter refers to any means or technique for controlling mutual phase shift between two electromagnetic waves travelling in two respective optical paths. One exemplary technique involves altering the index of refraction of the optical path, by using a temperature difference between the two optical paths. For instance, the optical fiber may be locally heated in one of the optical paths. The heating alters the index of refraction, which in turn alters the optical path length of the electromagnetic wave travelling in the heated optical path. Any phase shift control may take place virtually anywhere along the optical path, or the phase shift control may take place in a distributed manner. Any phase shift of a given sign (plus or minus) in one optical path (A or B) may be replaced by a phase shift of the opposite sign (minus or plus) in the other optical path (B or A). Yet further, the non-linear elements, such as saturable absorbers or semiconductor optical amplifiers (SOA) may be used for integrated phase shift control by adjusting their temperature, bias current or the optical power traversing the non-linear element.

The number of limiting amplification and optional Mamyshev regeneration stages is not limited to one limiting amplification stage and one Mamyshev regeneration stage, but the invention may contain several limiting amplification and several Mamyshev regeneration stages. For example, in FIG. 4 the first regeneration stage 4-3 without Mamyshev regeneration may be followed by a second regeneration stage 4-3 that implements the Mamyshev regeneration. In FIG. 11 a similar variation of the embodiment is manifested by following means: the amplitude regenerator outputs 11-37, 11-38 are coupled to another amplitude regenerator inputs 11-35, 11-36, respectively. Either of these two amplitude regenerators may or may not contain the bandpass filters BPF2 for Mamyshev regeneration. An arrangement where the amplitude regenerator contains several amplitude regenerators may be beneficial in cases, where, for instance, the input optical signal is weak and a limiting amplification is performed before the second limiting amplification, which is optimized for broadening and/or frequency shifting of the signal spectrum. In other words, the different amplitude regenerators may be optimized for different operations, such as for spectral broadening (in conjunction of Mamyshev regeneration), or for limiting amplification of weak input signals.

The location of the first and second bandpass filters BPF1 and BPF2 may vary within a receiver. For instance, the first bandpass filter BPF1 may be installed at any one or more locations before the location of the spectral broadening and/or frequency shifting. The first bandpass filter BPF1 can thus be located before the modulation conversion means (such as the delay interferometer), after the modulation conversion means, or inside the modulation conversion means. Each of the bandpass filters BPF1 and/or BPF2 can be a wavelength multiplexer or demultiplexer used in WDM systems to separate different wavelength channels from each other. The second bandpass filter BPF2 can be located anywhere between the location of the spectral broadening and/or frequency shifting and photoelectric conversion means.

The first and second bandpass filters BPF1, BPF2 may be provided by means of thin film coatings, waveguide gratings, finite impulse response (FIR) filters, such as asymmetric Mach-Zehnder interferometers, resonators, arrayed waveguide gratings, or any combination of these or other filters known in the art. The filters may be tunable, such that the transmission spectrum may be altered by changing a voltage (as the case is with liquid crystal filters), temperature, or some other physical parameter. For example, the filters may have a periodic transmission function at a frequency of 50 GHz or 100 GHz, in which case a single filter component may be used to filter many different wavelengths separately or simultaneously. The frequency grid may be one provided by a standardization body, such as the International Telecommunication Union (ITU).

The limiting amplification and/or spectral broadening and/or frequency shifting may be provided by means other than semiconductor optical amplifiers. For example, the limiting amplification may be obtained by parametric amplification in glass or semiconductor waveguide. The spectral broadening can likewise be obtained in appropriately dimensioned glass or semiconductor waveguides.

The photoconversion may be obtained by photodiodes, phototransistors, or metal-semiconductor-metal detectors, or by other means known in the art.

The optical couplers used in the various embodiments of the present invention, including the 3 dB couplers and couplers with different coupling ratios, can be constructed by using any of several construction techniques, including but not limited to partially reflecting mirrors, waveguides coupled to one another via an evanescent field, or gratings.

As stated in several contexts above, the drawings are intended to be schematic in the sense that they primarily illustrate the logical arrangement of the novel elements of the invention. Those skilled in the art will understand that practical working implementations based on such schematic drawings may include additional components which are not specifically illustrated or described. Optical isolators or circulators that were described in connection with FIGS. 9 and 10 are illustrative but non-restrictive examples of such components. Wave plates, half-wave plates or other components which affect polarization, may also be inserted at various points, as needed. Furthermore, the lengths of the various optical paths in the drawings do not necessarily reflect the optical path lengths in practical working implementations.

### Reference Documents

1. US patent application 2006/0204248 by Vladimir Grigoryan et al.
2. Pontus Johannison et al.: “Suppression of phase error in differential phase-shift keying data by amplitude regeneration”, Optics Letters; May 15, 2006; Vol. 31, No 10.
3. Chia Chien Wei et al.: “Convergence of phase noise in DPSK transmission systems by novel phase noise averagers”, Optics Express; Oct. 16, 2006; Vol. 14, No 21, abbr. “Wei”.
4. P. V. Mamyshev: “All-optical data regeneration based on self-phase modulation effect”, in Proceeding of 24th European Conference on Optical Communications; Sep. 20-24, 1998, Madrid, Spain.
5. M. Rochette et al.: “Bit-Error-Ratio Improvement With 2R Optical Regenerators”, IEEE Photonics Technology Letters; April, 2005; Vol. 17, No. 4.

1. An apparatus for processing an optical input signal carrying symbols, the apparatus comprising at least one optical system having the following elements:
modulation conversion means for converting the optical signal from a first modulation format to a second modulation format, wherein
the first modulation format involves a modulation of a set of physical parameters selected from a group consisting of phase, frequency and polarization state, such that each symbol has a unique nominal value of the set of physical parameters; and
the second modulation format is at least partially amplitude modulated, such that each symbol has a unique combination of nominal set of the physical parameters and nominal amplitude;
and wherein the modulation conversion means comprises:
a signal splitter for splitting the optical input signal into two optical partial signals, each of which is directed to a respective optical path;
delay elements for causing a mutual temporal difference between the two optical partial signals directed to the respective optical paths;
at least one non-linear regenerator having at least two ports and a gain which depends on the combined signal power directed to the at least two ports; and
means for directing the optical partial signals or derivatives thereof from the modulation conversion means to one or more photo detector stages in said at least partially amplitude-modulated format.

2. The apparatus according to claim 1, wherein the at least one optical system comprises an optical coupler or circulator for each of the optical paths; and wherein the at least one limiting amplifier is located between the optical coupler or circulator for each of the optical paths.

3. The apparatus according to claim 1, wherein the at least one optical system comprises an optical coupler for each of the optical paths, and the optical coupler is preceded by a respective optical isolator.

4. The apparatus according to claim 1, wherein the mutual temporal difference between the two optical partial signals is dimensioned such that symbols directed to the respective optical paths collide at the at least one limiting amplifier.

5. The apparatus according to claim 1, wherein the apparatus comprises two optical systems arranged in parallel and wherein the modulation conversion stages of the two optical systems exhibit mutually different phase shifts.

6. The apparatus according to claim 1, wherein:
the modulation conversion means is further configured to transform the optical signal from a first phase/amplitude-modulation format to a second phase/amplitude-modulation format;
wherein the optical signal experiences constructive/destructive interference at a first symbol pair in the first phase/amplitude-modulation format and at a second symbol pair in the second phase/amplitude-modulation format;
wherein the first symbol pair and the second symbol pair exhibit respective phase angles which differ from one another by a predetermined amount.

7. The apparatus according to claim 6, wherein the phase-shifting caused by the modulation conversion stage corresponds to the difference between the predetermined phase value pairs at which the two regeneration stages cause the constructive/destructive interference.

8. The apparatus according to claim 1, wherein the at least one non-linear regenerator is configured to cause a signal spectrum broadening and/or shifting in the optical signal; and wherein the apparatus further comprises:
at least one first bandpass filter before the at least one non-linear regenerator, the first bandpass filter having a first pass band;
at least one second bandpass filter after the at least one non-linear regenerator, the at least one second bandpass filter having a second pass band;
wherein the second band pass at least partially excludes the signal spectrum broadening and/or shifting.

9. The apparatus according to claim 8, wherein the at least one non-linear regenerator is configured to cause said spectral broadening by means of self-phase modulation.

10. The apparatus according to claim 1, wherein the one or more photo detector stages are located in an external apparatus.

11. A method for processing an optical input signal carrying symbols, the method comprising:
performing modulation conversion on the optical signal from a first modulation format to a second modulation format, wherein
the first modulation format involves a modulation of a set of physical parameters selected from a group consisting of phase, frequency and polarization state, such that each symbol has a unique nominal value of the set of physical parameters; and
the second modulation format is at least partially amplitude modulated, such that each symbol has a unique combination of nominal set of the physical parameters and nominal amplitude;
and wherein the modulation conversion comprises:
splitting the optical input signal into two optical partial signals, each of which is directed to a respective optical path;
causing a mutual temporal difference between the two optical partial signals directed to the respective optical paths;
regenerating the two optical partial signals in at least one limiting amplifier having at least two ports and a gain which depends on the combined signal intensity directed to the at least two ports;
generating an electrical signal, from at least one of the regenerated optical partial signals; and
keeping the two optical partial signals in said at least partially amplitude-modulated format from the modulation conversion to the generation of the electrical signal.
